(19) United States
(12) Patent Application Publication
(10) Pub. No.: US 2020/0097412 A1
(43) Pub. Date: Mar. 26, 2020

(54) PREDICTIVE DYNAMIC CONTEXTUAL CACHE LOADING

(71) Applicant: International Business Machines Corporation, Armonk, NY (US)

(72) Inventors: Al Chakra, Apex, NC (US); Faisal Ghaffar, Dunboyne (IE); Ahmad Abdul Wakeel, Mulhuddart (IE)

(21) Appl. No.: 16/142,357

(22) Filed: Sep. 26, 2018

(51) Int. Cl. G06F 12/0862

(52) U.S. Cl. CPC G06F 12/0862; G06F 2212/6024; G06F 2212/602; G06F 2212/1021

(57) ABSTRACT

Provided are embodiments for predictive dynamic contextual cache loading. The embodiments include analyzing application usage patterns of one or more applications, determining a candidate set of data records from a plurality of data records associated with the one or more applications, and calculating a cache-add quotient (CAQ) score based at least in part on the candidate set of data records. The embodiments also include marking one or more data records of the candidate set of data records based at least in part on the CAQ score, ranking the one or more data records of the candidate set of data records based on the CAQ score, and loading one or more data records of the candidate set of data records based at least in part on the ranking.

### BACKGROUND

The present invention generally relates to caching, and more specifically to predictive dynamic contextual cache loading.

In today's environment, enterprise applications require a large amount of data. The enterprise data is generally collected by a data collector component, where the data collector components are configured to collect data from remote/local data sources and bring it to local database/in-memory cache. There may be a need to provide techniques to efficiently select the enterprise data to add to a cache to be accessed by the system.

### SUMMARY

Embodiments of the present invention are directed to a computer-implemented method for dynamic contextual cache loading. A non-limiting example of the computer-implemented method includes analyzing application usage patterns of one or more applications, determining a candidate set of data records from a plurality of data records associated with the one or more applications, and calculating a cache-add quotient (CAQ) score based at least in part on the candidate set of data records. The computer-implemented method also includes marking one or more data records of the candidate set of data records based at least in part on the CAQ score, ranking the one or more data records of the candidate set of data records based on the CAQ score, and loading one or more data records of the candidate set of data records based at least in part on the ranking.

Embodiments of the present invention are directed to a system for dynamic contextual cache loading. A non-limiting example of the system includes a storage medium, the storage medium being coupled to a processor. The processor is configured to analyze application usage patterns of one or more applications, determine a candidate set of data records from a plurality of data records associated with the one or more applications, and calculate a cache-add quotient (CAQ) score based at least in part on the candidate set of data records. The processor is also configured to mark one or more data records of the candidate set of data records based at least in part on the CAQ score, rank the one or more data records of the candidate set of data records based on the CAQ score, and load one or more data records of the candidate set of data records based at least in part on the ranking.

Embodiments of the invention are directed to a computer program product for dynamic contextual cache loading, the computer program product comprising a computer-readable storage medium having program instructions embodied therewith. The program instructions are executable by a processor to cause the processor to perform a method. A non-limiting example of the method includes analyzing application usage patterns of one or more applications, determining a candidate set of data records from a plurality of data records associated with the one or more applications, and calculating a cache-add quotient (CAQ) score based at least in part on the candidate set of data records. The method also includes marking one or more data records of the candidate set of data records based at least in part on the CAQ score, ranking the one or more data records of the candidate set of data records based on the CAQ score, and loading one or more data records of the candidate set of data records based at least in part on the ranking

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating one example of a processing system for practice of the teachings herein;

FIG. 2 depicts a CAQ calculator for predictive dynamic cache loading in accordance with one or more embodiments of the invention;

FIG. 3 depicts a flowchart of a method for performing predictive dynamic cache loading in accordance with one or more embodiments of the invention;

FIG. 4 depicts a flowchart of a method for performing predictive dynamic cache loading in accordance with one or more embodiments of the invention; and

FIG. 5 depicts a computer program product in accordance with one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, a cache is used to temporarily store data so that future requests can be fulfilled faster and more efficiently. Caches are used to reduce latency. The value of a cache depends on the data it contains where the requests are serviced by the cache. In the event the requested data does not exist in the cache, the data must be obtained by re-computing a result or read from a slower data store.

The cache is limited in the amount of data that it can hold. The data that is added to the cache can be updated using a number of techniques. For example, the cache can hold the most frequently accessed data or the cache can hold data that was recently accessed. Some applications process a large amount of data. There is a need for a contextual aware application cache to maximize the user experience for that application.

A variety of techniques have been developed to determine the data that should be added to the cache. The techniques include upfront loading or lazy loading. Upfront cache loading techniques generally populate the cache with data at cache start-up based on some techniques such as miss-penalty. However, pre-fetching cache techniques generally lack awareness about the context under which a certain application is being used, predicting the data records that can be marked for pre-fetching, and rank order potential cache-able data records so that high ranked items are pre-loaded into the free cache.

Turning now to an overview of the aspects of the invention, one or more embodiments of the invention address the above-described shortcomings of the prior art by providing a technique for performing predictive dynamic contextual cache loading. The techniques predict a set of data records that an application will need based on the historical and contextual application usage history and behavior of a user. Given the set of data records, the technique further calculates a Cache Add Quotient (CAQ) for each data record using various parameters such as but not limited to a cost associated with keeping the data record in the cache, cost to retrieve data from the data source, cost to rerun complex query to obtain the result, priority of user logged in the application, etc. Using the calculated CAQ, the techniques pre-load the available cache with the highest ranked data records. Therefore, the cache can be loaded in an intelligent and predictive manner.

The above-described aspects of the invention address the shortcomings of the prior art by predictively and intelligently populating the available cache with data records that have been ranked based on the contextual information related to how a user interacts with one or more applications.

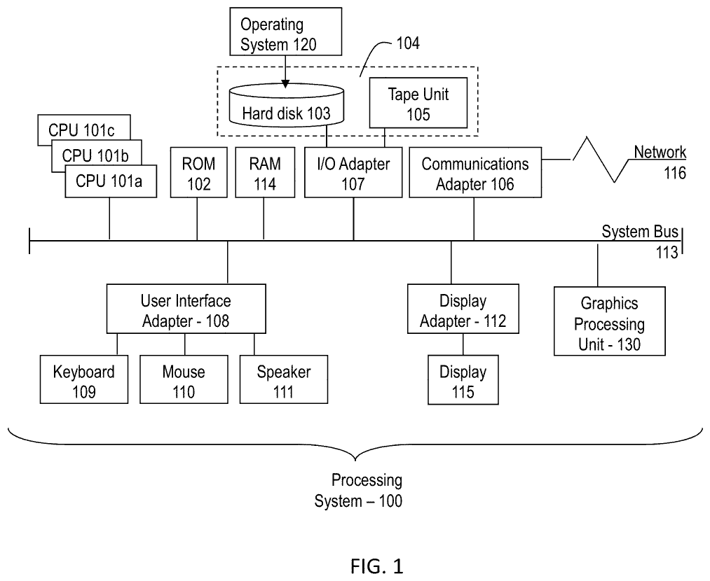

Turning now to a more detailed description of aspects of the present invention, FIG. 1 depicts a processing system 100 in accordance with one or more embodiments of the invention for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including the system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

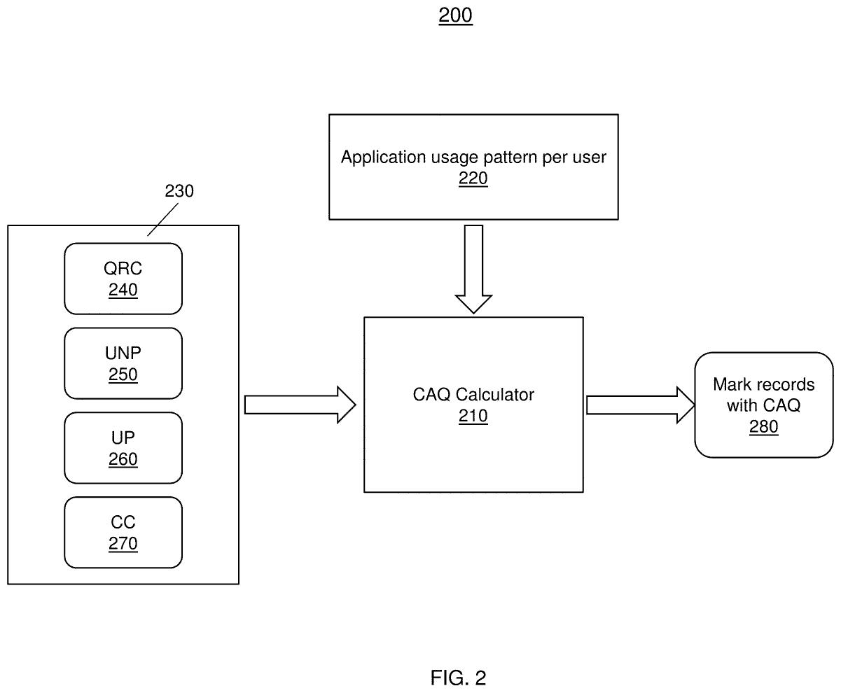

In FIG. 2, a system 200 for performing dynamic contextual cache loading in accordance with one or more embodiments. In FIG. 2, a cache-add quotient (CAQ) calculator 210 is configured to calculate a CAQ score for one or more data records of a set of candidate data records. The CAQ score is used to rank the data records and load available cache memory according to the rank.

The CAQ calculator 210 is configured to receive data from an application usage pattern data module 220 that indicates one or more users' usage patterns of applications. In addition, the usage patterns module 220 can determine the frequency, duration, and time of day a user accesses an application. The usage pattern can also include the queries that are generated and correlate them to a time of day to determine the probability and frequency of such queries. In addition, other information leading to how the user interacts with the application can be considered to determine a usage pattern. In addition, usage patterns can be determined for types of users based on their roles, title, priority, group, etc. In addition, a sequence of applications and requests corresponding to those requests can be monitored to determine a pattern.

In a non-limiting example, users having a particular role may be responsible for carrying out a particular set of tasks that generally requires a set of requests. Troubleshooting a particular issue may generate a particular pattern of queries which can be leveraged to populate data records in a cache. The usage pattern module 220 can determine patterns based on machine-learning techniques. In addition, as usage patterns change over time the information provided to the CAQ calculator 210 can be updated to analyze the data records based on the latest patterns of use.

FIG. 2 also depicts a set of parameters/constraints 230 that are used by the CAQ calculator 210 that are factored into the calculation. The set of parameters 230 include a cost to run/rerun query (QRC) value that can be determined by the QRC module 240. For example, a cost can be obtained to perform the query where complex queries will have a higher cost than non-complex queries. In one or more embodiments of the invention, the amount of time it takes to run a query can be correlated to a QRC cost and factored into the calculation of the CAQ calculator. The cost can be re-calculated over different configurable intervals of time to obtain the most up-to-date and accurate costs for the calculation.

The set of parameters 230 also include a probability that a user will need the result at a particular time (UNP) value that can be determined by the UNP module 250. In one or more embodiments of the invention, the probability can analyze the times and frequency that a particular application, query, set of data records, etc. is accessed to determine a probability over a configurable interval of time. The UNP score can be factored into the calculation performed by the CAQ calculator 210. By analyzing the history and application interactions of a plurality of users a probability can be calculated that the user will need the result of the cache addition candidate result.

The set of parameters 230 can include a user priority (UP) value that can be determined by the UP module 260. In various systems, different users may have different priorities. For example, permanent employees can have a different priority than contractors, where contractors have different priorities than guests. Priorities can also be based on the user's role such as president and vice president. Group membership can also be used to designate a priority. The priority can be used as a scalar multiple to increase the score based on the user's priority. This can increase the chances of having a higher priority user's data pre-loaded into the available data cache.

The set of parameters 230 include a cost to keep the result in the cache (CC) value that can be determined by the CC module 270. Keeping a resulting set of data records in the cache has a cost associated with it. As the set of data records are stored in the cache, other data records cannot be stored in the same location of the cache. This cost is proportional to the size of the data item in the cache and the time to keep it. For example, in a cache having a fixed size each bit of the cache taken by a data item adds to the cost (e.g., per megabyte and per minute) for storing the data item. In one or more embodiments of the invention, given a set of constraints and determined usage patterns a CAQ score is calculated and used to pre-load a data record into a cache.

The system 200 is configured to analyze applications and its use by a particular user to determine a usage pattern. The system determines one or more data records that are associated with the usage pattern. With the candidate set of data records, the system 200 calculates a CAQ score for each data record using the following parameters/constraints: the cost to keep the data record(s) in a cache (CC); cost to retrieve data from the data source (e.g. disk storage, etc.); cost to rerun complex query to obtain result (QRC); probability that user will need the result at a particular time period (UPN); and priority of user logged in the application (UP). It should be understood that other parameters/constraints can be used and are not limited by those provided in this example. The CAQ score is calculated based on the factors above and each of the data records are marked with a respective CAQ score as shown in block 280.

In a non-limiting example, a smart gas network system is considered. The smart gas system is configured to display a network of gas pipes and their status on a geospatial map. There are various users that use the smart gas system in different ways. For example, different types of users can include operators, supervisors, etc. The operators can use the smart gas system to monitor the gas pipe network and filter in/out a network region where a supervisor can generate different reports such as reports for gas consumption in a city, gas leaks over a period of time, etc.

On a typical day, an operator that uses the application performs a set of actions using various functions of the application. The operator can filter through various functions of the application such as selecting a region for pipe valve inspection and then the operator may select a specific pipe to view the details of a pipe, valve, gas pressure status, etc.

The system identifies a set of actions that the operator performs between 9:00 am and 1:00 pm and a different set of actions between 1:00 pm and 5:00 pm. One or more embodiments of the invention leverages these patterns along with other constraints such as access privileges of users, application function, etc. to determine a set of potential data records to add into the cache. Although, a gas network system application is described the techniques described above are not limited to the gas network system application and can be applied to a variety of system applications.

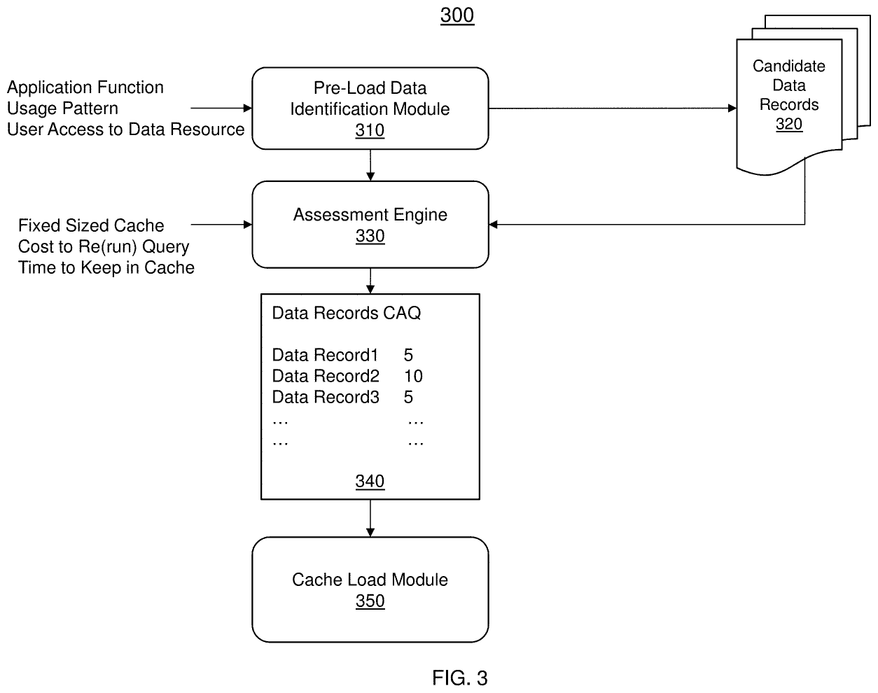

In FIG. 3, a system 300 for dynamically loading a cache based on user context is shown. A “pre-loading data identification module” 310 is configured to receive application function information, usage pattern information, user access to data resource information, etc. The pre-load data identification module 310 identifies a candidate set of cacheable data records 320 based on the application usage pattern data. In one or more embodiments of the invention, the candidate set of data records 320 is a subset of the all of the data records.

The assessment engine 330 is configured to calculate CAQ scores for one or more data records based on one or more factors and is configured to receive various parameters that are used to calculate the CAQ score such as the fixed sized cache, cost to re(run) query, time to keep in the data records in the cache, etc. This data is correlated with the candidate set of cacheable data records 320. The assessment engine 330 is configured to calculate and associate a CAQ score with the various sets of data records.

At block 340, a table is shown correlating data records to a CAQ score. In one or more embodiments of the invention, the data records are ranked and are loaded into the available cache according to the ranking. The table includes a “Data Record1” that has a CAQ score 5; a “Data Record2” having a CAQ score of 10; and a “Data Record3” having a CAQ score of 5.

The cache load module 350 is configured to select and load one or more data records in the available cache according to the rank. In one example, the highest ranked data records from the candidate set of data records are pre-loaded into the available free cache. For example, the “Data Record2” will be loaded into the available cache before the other data records shown in the table. Although only three data records are shown in the table, it should be understood that any number of data records can be analyzed by the system 300. In one or more embodiments of the invention, a CAQ score threshold can be implemented to load the cache. For example, a CAQ for a data record that does not exceed the CAQ score threshold will not be considered to be added to the cache. Those data records having CAQ scores that exceed the threshold will be considered for ranking and adding to the cache. For example, if the CAQ score threshold is “7” only the “Data Record2” will be added to the cache.

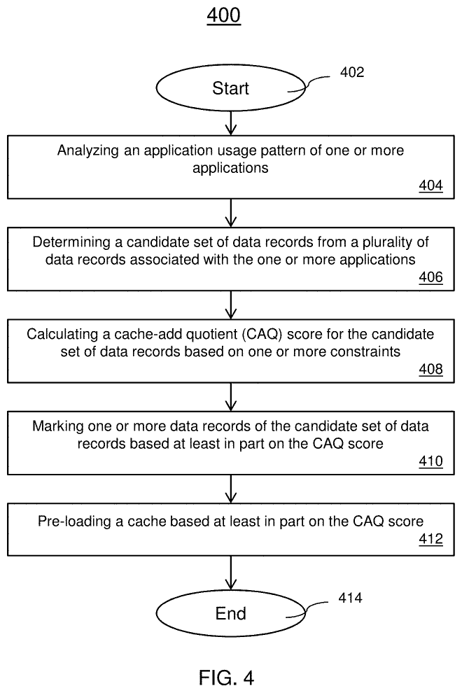

FIG. 4 depicts a flowchart of a method 400 for performing predictive dynamic cache loading in accordance with one or more embodiments of the invention. The method 400 begins at block 402 and proceeds to block 404 which provides for analyzing application usage patterns of one or more applications. The method 400 continues and proceeds to block 406 which provides for determining a candidate set of data records from a plurality of data records associated with the one or more applications.

At block 408, the method 400 provides for calculating a cache-add quotient (CAQ) score based at least in part on the candidate set of data records. In one or more embodiments of the invention, the CAQ score for each data record of the candidate set of data records are calculated based on a QRC value, UNP value, UP value, CC value, etc.

In one or more embodiments of the invention, the CAQ score is calculated according to Equation 1 as follows:

CAQ=Δcost·Δuse (Eq. 1)

where Δcost=∫f(CC)d(QRC); and Δuse=∫f(UNP)d(UP). As shown, the Δcost is a function of the cost to keep the data and the cost of running the query and Δuse is a function of the probability the user will need the data and the user priority.

The method 400, at block 410, provides for marking one or more data records of the candidate set of data records based at least in part on the CAQ score. In one or more embodiments of the invention, the marked records indicate the CAQ score and/or a ranking of the candidate set of data records. Block 412 provides for pre-loading a cache based at least in part on the CAQ score. In some embodiments of the invention, a CAQ threshold score can be used to further limit the number of data records that will be added to the cache. The method 400 ends at block 414. In one or more embodiments of the invention, the method 400 can be periodically performed at a configurable interval or upon the occurrence of an event.

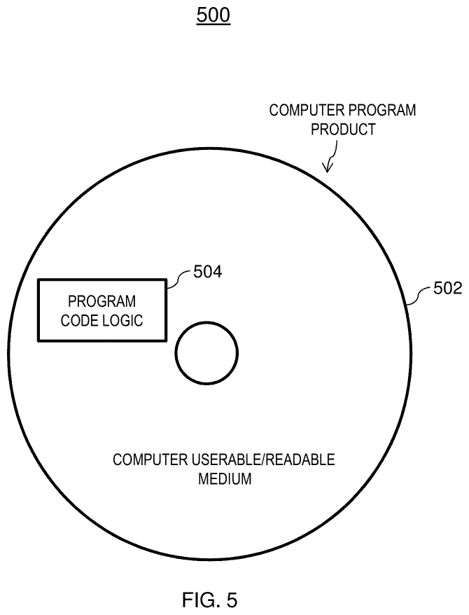

Referring now to FIG. 5, a computer program product 500 in accordance with an embodiment that includes a computer-readable storage medium 502 and program instructions 504 is generally shown.

The technical effects and benefits improve over the prior art by intelligently predicting a set of data records that may be required by an application based on a user's context. The context includes factoring an application usage pattern for users and correlating them to data records. In addition, the technical effects and benefits improve over the prior art by reducing multiple, redundant, and/or unnecessary queries to perform a search for data records.

The techniques described herein provide a highly dynamic and efficient cache building system. The technical effects and benefits provide for predictively and dynamically performing cache loading of a set of data records that an application utilizes based on the contextual information of an application user's behavior. The technical effects and benefits include optimizing system resources and response time by optimizing cache flushes.

The techniques described herein provide a cognitive system that analyzes a user's application usage to understand the context of usage and identify the associated data records. The cognitive system calculates a CAQ score for each data record by correlating usage patterns with a set of constraints. With known CAQs for the candidate data records, the system pre-loads the highest ranked data records into the available free cache. The dynamic ranking performed in this manner can be further used for multi-level caching.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method for predictive dynamic contextual cache loading comprising:
analyzing application usage patterns of one or more applications, wherein the usage patterns are based at least in part on a user role, wherein the user role is associated with a priority;
determining a candidate set of data records from a plurality of data records associated with the one or more applications;
calculating a cache-add quotient (CAQ) score based at least in part on the candidate set of data records;
marking one or more data records of the candidate set of data records based at least in part on the CAQ score;
ranking the one or more data records of the candidate set of data records based on the CAQ score; and
loading, in a cache, one or more data records of the candidate set of data records based at least in part on the ranking, wherein data records of a higher priority user are loaded in the cache prior to a lower priority user.

2. The computer-implemented method of claim 1, wherein the usage pattern is further based on at least one of a time period, an application type, or a type of user.

3. The computer-implemented method of claim 1, further comprising determining an available capacity on the cache; and
loading one or more data records of the cache based at least in part on the available capacity of the cache.

4. The computer-implemented method of claim 1, wherein ranking the candidate set of data records comprises comparing CAQ scores to a CAQ threshold score; and
loading the one or more data records based on the CAQ threshold score.

5. The computer-implemented method of claim 1, further comprising updating at least one of the application usage patterns or the candidate set of data records.

6. (canceled)

7. A system for performing dynamic cache loading, the system comprising:
a storage medium, the storage medium being coupled to a processor;
the processor configured to:
analyze application usage patterns of one or more applications, wherein the usage patterns are based at least in part on a user role, wherein the user role is associated with a priority;
determine a candidate set of data records from a plurality of data records associated with the one or more applications;
calculate a cache-add quotient (CAQ) score based at least in part on the candidate set of data records;
mark one or more data records of the candidate set of data records based at least in part on the CAQ score;
rank the one or more data records of the candidate set of data records based on the CAQ score; and
load, in a cache, one or more data records of the candidate set of data records based at least in part on the ranking, wherein data records of a higher priority user are loaded in the cache prior to a lower priority user.

8. (canceled)

9. The system of claim 7, wherein the usage pattern is further based on at least one of a time period, an application type, or a type of user.

10. The system of claim 7, wherein the processor is configured to determine an available capacity on the cache; and
load one or more data records of the cache based at least in part on the available capacity of the cache.

11. The system of claim 7, wherein ranking the candidate set of data records comprises comparing CAQ scores to a CAQ threshold score; and
loading the one or more data records based on the CAQ threshold score.

12. The system of claim 7, wherein the processor is configured to update at least one of the application usage patterns or the candidate set of data records.

13. A computer program product for performing dynamic cache loading, the computer program product comprising:
a computer-readable storage medium having stored thereon program instructions executable by a processor to cause the processor to:
analyze application usage patterns of one or more applications, wherein the usage patterns are based at least in part on a user role, wherein the user role is associated with a priority;
determine a candidate set of data records from a plurality of data records associated with the one or more applications;
calculate a cache-add quotient (CAQ) score based at least in part on the candidate set of data records;
mark one or more data records of the candidate set of data records based at least in part on the CAQ score;
rank the one or more data records of the candidate set of data records based on the CAQ score; and
load, in a cache, one or more data records of the candidate set of data records based at least in part on the ranking, wherein data records of a higher priority user are loaded in the cache prior to a lower priority user.

14. The computer program product of claim 13, wherein the usage pattern is further based on at least one of a time period, an application type, or a type of user.

15. The computer program product of claim 13, wherein the instructions are further executable by the processor to cause the processor to determine an available capacity on the cache; and
load one or more data records of the cache based at least in part on the available capacity of the cache.

16. The computer program product of claim 13, wherein ranking the candidate set of data records comprises comparing CAQ scores to a CAQ threshold score; and
loading the one or more data records based on the CAQ threshold score.

17. The computer program product of claim 13, wherein the instructions are further executable by the processor to cause the processor to update at least one of the application usage patterns or the candidate set of data records.

18. (canceled)
